(19) United States
(12) Patent Application Publication
(10) Pub. No.: US 2024/0110664 A1
(43) Pub. Date: Apr. 4, 2024

(54) OUTDOOR STRUCTURES AND CLIPS FOR ATTACHING OBJECTS TO OUTDOOR STRUCTURES

(71) Applicant: CANADIAN TIRE CORPORATION, LIMITED, Toronto (CA)

(72) Inventors: Luca ALVERGUE, Burlington (CA); Jayn MCINTOSH, Toronto (CA); Lisa SIMLA, Toronto (CA)

(73) Assignee: CANADIAN TIRE CORPORATION, LIMITED, Toronto, ON (CA)

(21) Appl. No.: 18/373,651

(22) Filed: Sep. 27, 2023

Related U.S. Application Data
(60) Provisional application No. 63/411,515, filed on Sep. 29, 2022.

(51) Int. Cl. F16M 13/02; E04F 10/08

(52) U.S. Cl. CPC F16M 13/022; E04F 10/08

(57) ABSTRACT

Outdoor structures and clips for attaching objects to frame members of outdoor structures are provided. A frame member includes a channel having an opening defined between two flanges having a flange thickness. A clip for attaching an object to the frame member includes a head sized to be received in the channel of the frame member via the opening and frictionally engaged with the channel upon rotation of the head when the head is received in the channel. The clip includes a body attached to the head and configured to engage with the object. The head and the body of the clip define a gap therebetween for receiving the flanges when the head is engaged with the channel. The gap has a gap thickness that is smaller than the flange thickness to define an interference fit between the flanges and the clip.

### CROSS REFERENCE TO RELATED APPLICATION AND CLAIM OF PRIORITY

The present application claims priority to U.S. provisional patent application No. 63/411,515 filed on Sep. 29, 2022, the entire contents of which are hereby incorporated herein by reference.

### TECHNICAL FIELD

The disclosure relates generally to outdoor structures such as pergolas and gazebos used in outdoor living spaces, and more particularly to attaching objects to such outdoor structures.

### BACKGROUND

Outdoor structures such as pergolas are used in gardens, on patios and on decks to provide shelter or cover from the sun, wind and/or rain in an outdoor environment that may be used for cooking, dining and/or entertaining. Users of outdoor structures sometimes attach objects such as lighting and decorations to the outdoor structures. However, existing methods of attaching objects to outdoor structures can require tools and/or can negatively affect the appearance of the outdoor structure. Improvement is desirable.

### SUMMARY

In one aspect, the disclosure describes an outdoor structure for an outdoor living space. The outdoor structure comprises:
a post extending substantially vertically and having a channel extending along the post;
a beam supported by the post and extending transversally to the post; and
a clip for attaching an object to the post, the clip including:
a head received in the channel of the post and frictionally engaged with one or more surfaces defining the channel; and
a body attached to the head and configured to engage with the object.

The post may include a flange partially defining an opening of the channel. The head and the body of the clip may define a gap therebetween. The flange may be received in the gap and press-fitted between the head and the body.

The flange may be a first flange. The post may include a second flange. The opening of the channel may be defined between the first flange and the second flange. The second flange may be received in the gap and press-fitted between the head and the body.

The head may be attached to the body via a neck extending between the first flange and the second flange. The neck may be spaced apart from both the first flange and the second flange.

The head of the clip may be tapered away from the body. The channel may have a longitudinal channel axis and a cross-sectional profile in a plane normal to the longitudinal channel axis. The cross-sectional profile of the channel may taper away from the opening of the channel.

The head of the clip may have a top surface at a distal extremity of the head opposite the body. The channel may have a back surface opposite the opening of the channel. The top surface of the head of the clip may be in contact with the back surface of the channel.

The head may have an elongated shape having a longitudinal head axis. Opposite axial ends of the head along the longitudinal head axis may be in contact with opposite side surfaces of the channel.

The head may be rotatably attached to the body.

The clip may include two independently rotatable heads frictionally engaged with the one or more surfaces defining the channel.

The body may include a hook. The hook may include a ledge to hinder the object from becoming disengaged from the hook. The hook may include a tab to facilitate opening or closing of the hook.

The hook may include a brace in a corner region of a throat of the hook to reinforce the hook.

The body may include a toggle ball holder.

The body may include an electric receptacle holder.

The body may include an electronic display device holder.

The body may include a lamp holder.

The outdoor structure may be a pergola.

Embodiments may include combinations of the above features.

In another aspect, the disclosure describes a kit comprising:
a frame member defining a channel, the frame member including a flange at least partially defining an opening of the channel, the flange having a flange thickness; and
a clip for attaching an object to the frame member, the clip including:
a head sized to be received in the channel via the opening and frictionally engaged with the channel upon rotation of the head when the head is received in the channel; and
a body attached to the head and configured to engage with the object, the head and the body defining a gap therebetween for receiving the flange when the head is frictionally engaged with the channel, the gap having a gap thickness that is smaller than the flange thickness to define an interference fit between the flange and the clip.

The frame member may be a post of an outdoor structure.

The flange may be a first flange. The frame member may include a second flange. The opening of the channel may be defined between the first flange and the second flange. The gap is configured to: receive the second flange therein when the head is frictionally engaged with the channel; and define an interference fit between the second flange and the clip.

The head may be attached to the body via a neck extending between the first flange and the second flange. The neck may be spaced apart from both the first flange and the second flange.

The body may include a hook.

The body may include a toggle ball holder.

The body may include an electric receptacle holder.

The body may include an electronic display device holder.

The body may include a lamp holder.

Embodiments may include combinations of the above features.

In another aspect, the disclosure describes a clip for attaching an object to a channeled frame member in a tool-less manner. The channeled frame member may include flanges defining an opening of a channel therebetween. The flanges may have a flange thickness. The clip may comprise:
a head sized to be received in the channel via the opening and frictionally engaged with the channel upon rotation of the head when the head is received in the channel; and
a body attached to the head and configured to engage with the object, the head and the body defining a gap therebetween for receiving the flanges when the head is engaged with the channel, the gap having a gap thickness that is smaller than the flange thickness to define an interference fit between the flanges and the clip.

The head may be attached to the body via a neck extending between the flanges. The neck may be spaced apart from the flanges.

The head may be rotatable relative to the body.

The clip may include two independently rotatable heads to be received in the channel via the opening and frictionally engaged with the channel upon rotation of the heads when the heads are received in the channel.

The body may include a hook. The hook may include a ledge to hinder the object from becoming disengaged with the hook. The hook may include a tab to facilitate opening or closing of the hook.

The body may include a toggle ball holder.

The body may include an electric receptacle holder.

The body may include an electronic display device holder.

The body may include a lamp holder.

Embodiments may include combinations of the above features.

In another aspect, the disclosure describes a method of attaching an object to a frame member in a tool-less manner. The frame member may include two flanges defining therebetween an opening of a channel extending along the frame member. The method may comprise:
when a head of a clip is inserted into the channel of the frame member and the head of the clip is rotated relative to the channel:
causing frictional engagement between the head and one or more surfaces defining the channel;
receiving the two flanges into a gap defined between the head and a body of the clip; and
press-fitting the two flanges between the head and the body of the clip to define an interference fit between the clip and the two flanges; and
attaching the object to the clip.

The frame member may be oriented substantially vertically.

The frame member may be oriented substantially horizontally.

The method may comprise cammingly engaging the head with the one or more surfaces defining the channel.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective view of an exemplary outdoor structure with insets showing exemplary clips attachable to the outdoor structure;

FIGS. 2A-2C are perspective views illustrating a method of attaching the clip of FIG. 1 to an outdoor structure;

FIG. 3 is a cross-sectional profile of a post of the outdoor structure of FIG. 1 taken along line 3-3 in FIG. 1;

FIG. 4 is a cross-sectional profile of a beam of the outdoor structure of FIG. 1 taken along line 4-4 in FIG. 1, together with the clip of FIG. 1 attached thereto;

FIG. 5 shows an enlarged view of region 5 of FIG. 3 showing a channel the cross-sectional profile of the post of FIG. 3 together with a front view of the clip of FIG. 1 suitable for engagement with the channel;

FIG. 6 is a schematic view of a cross-sectional profile of a head of the clip of FIG. 1 taken along line 6-6 in FIG. 5 at an unlocked position and at a locked position relative to the channel;

FIG. 7 is a perspective view of the clip of FIG. 1;

FIG. 8 is a left side view of the clip of FIG. 1;

FIG. 9 is a top view of the clip of FIG. 1;

FIGS. 10 and 11 are perspective views of another exemplary clip including a toggle ball holder;

FIGS. 12 and 13 are perspective views of another exemplary clip including electrical outlets;

FIGS. 14 and 15 are perspective views of another exemplary clip including an electronic display device holder;

FIGS. 16 and 17 are perspective and rear views respectively of another exemplary clip including a lamp; and

FIG. 18 is a perspective partially transparent view of part of the clip of FIGS. 16 and 17 attached to a frame member.

### DETAILED DESCRIPTION

The present disclosure relates to outdoor structures typically used in outdoor (e.g., back yard) living spaces, and clips for attaching objects to outdoor structures in a tool-less manner. Such outdoor structures may include relatively light yard structures such as a pergolas, gazebos, arbors, sun rooms, greenhouses, privacy walls, awnings and trellises for example. However, it is understood that the clips disclosed here may also be used in other (e.g., indoor) applications for attaching objects to channeled frame members.

In some embodiments, the clips disclosed herein may provide a user-friendly and versatile way of attaching objects to outdoor structures in a tool-less and aesthetically pleasing manner. For example, in some embodiments, the clips disclosed herein may provide relatively secure attachment to channeled frame members in a twist-and-lock manner. In some embodiments, the clips disclosed herein may be used to attach objects to channeled frame members disposed at various orientations including vertical, horizontal and oblique.

The term “attached” may include both direct attachment (in which two elements contact each other) and indirect attachment (in which at least one additional element is located between the two elements).

The term “substantially” as used herein may be applied to modify any quantitative representation which could permissibly vary without resulting in a change in the basic function to which it is related. For example, a post as disclosed herein having a substantially vertical orientation may permissibly vary from a purely vertical orientation (e.g., +/−5 degrees from vertical) within the scope of the present disclosure if its function as a post is not materially altered. For example, a beam as disclosed herein having a substantially horizontal orientation may permissibly vary from a purely horizontal orientation (e.g., +/−5 degrees from horizontal) within the scope of the present disclosure if its function as a beam is not materially altered.

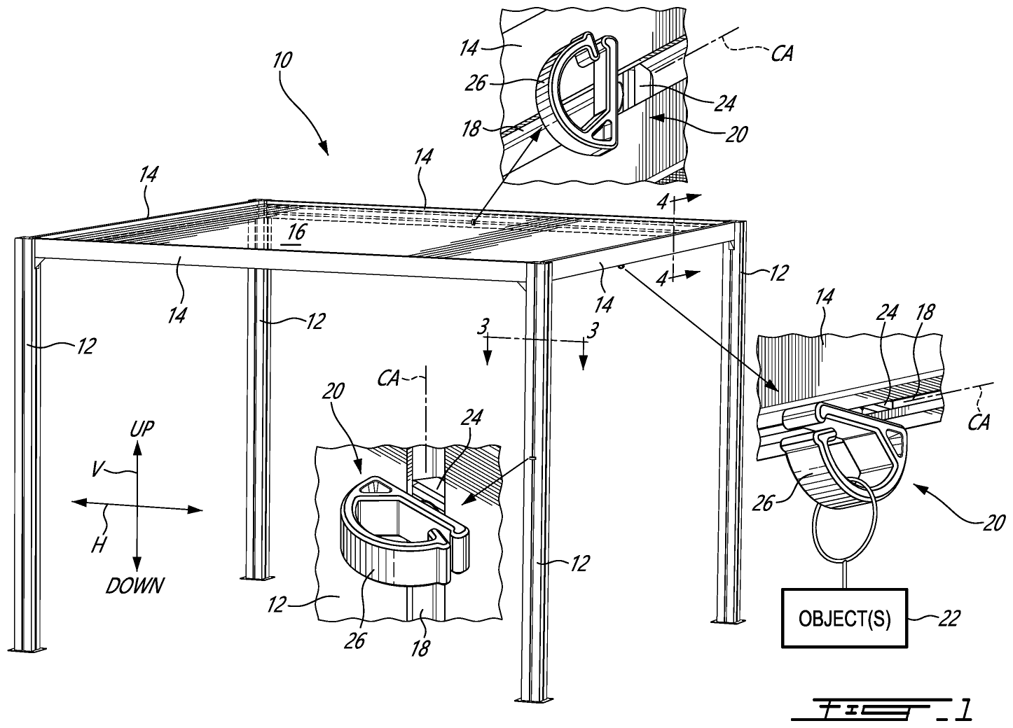

FIG. 1 is a perspective view of pergola 10 as a non-limiting example of an outdoor structure. It is understood that aspects of this disclosure are applicable to other types of outdoor structures including one or more channeled frame members (e.g., posts, beams, joists, rafters and rails). Pergola 10 may include posts 12 extending substantially vertically from the ground, beams 14 extending transversally to posts 12 (e.g., substantially horizontally) and attached to posts 12 so as to be supported by posts 12, and roof surface 16. In some embodiments, beams 14 may be arranged to define a four-sided structure supported by four posts 12 serving as support columns or uprights. One post 12 may be disposed at each corner of the four-sided structure defined by beams 14. In some embodiments, beams 14 may be attached (e.g., fastened) to posts 12 with suitable fasteners and brackets for example. Posts 12 and beams 14 may be made from any suitable structural material. In some embodiments, posts 12 and beams 14 may be made from a suitable polymeric or metallic material (e.g., aluminium) and manufactured using extrusion technologies.

Posts 12 and beams 14 may define a framework used to support roof surface 16 to provide a shade over an outdoor living space under pergola 10. In some embodiments, roof surface 16 may be a shade cloth attached to beams 14 and extending across the area defined between beams 14. Alternatively, pergola 10 may include a rigid roof surface 16. In some embodiments, pergola 10 may include an array of horizontal spaced-apart beams (e.g., joists) supported by posts 12 to provide shade. In some embodiments, pergola 10 may include trelliswork over which vines or other plants may be trained to grow.

In some embodiments, posts 12 and/or beams 14 may be channeled frame members meaning that posts 12 and/or beams 14 may each have one or more channels 18 formed therein. Channels 18 may each extend along its own longitudinal channel axis CA. One or more channels 18 may extend substantially vertically along substantially vertical posts 12 relative to vertical direction V. One or more channels 18 may extend substantially horizontally along substantially horizontal beams 14 relative to horizontal direction H.

FIG. 1 also shows an exemplary clip 20 (see insets) that may be attached to posts 12 and/or to beams 14 via channels 18. One or more clips 20 may be used to attach one or more objects 22 to posts 12 and/or beams 14. For example, clips 20 may be used to attached string lights, decorations and/or other objects to pergola 10. Clip 20 may include head 24 received in channel 18 and frictionally engaged with one or more internal surfaces of post 12 or beam 14 defining channel 18. Clip 20 may include body 26 attached to head 24 and configured to engage with object(s) 22. Clip 20 may be engaged with horizontally-extending channel 18 defined on a top side, bottom side or lateral side of beam 14. Clip 20 may be engaged with vertically-extending channel 18 defined on a lateral side of post 12. Clip 20 may be engaged with channel 18 that has channel axis CA oriented obliquely to vertical orientation V. For example, clip 20 may be engaged with channel 18 that has channel axis CA having an orientation that is greater than 0° and less than 45° from vertical orientation V.

Body 26 of clip 20 illustrated in FIG. 1 defines a hook as an example but it is understood that other types of clips (e.g., including those disclosed herein) for engaging with different types of objects 22 may also be attached to pergola 10 in a similar tool-less manner.

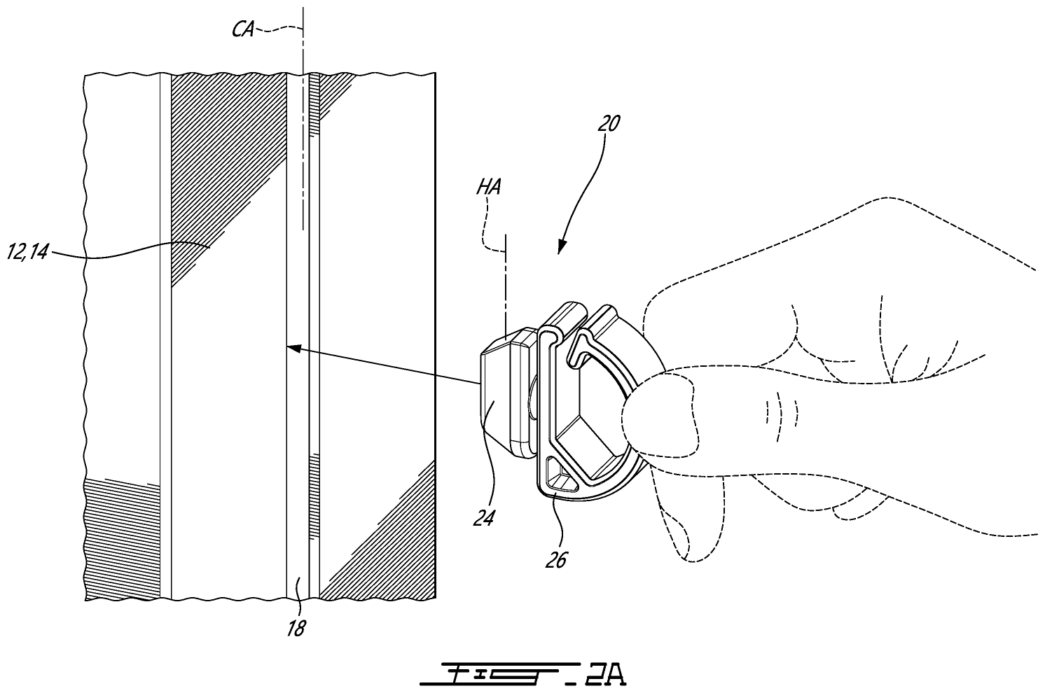

FIGS. 2A-2C are perspective views illustrating a method for attaching clip 20 to post 12 or to beam 14 of pergola 10. Clip 20 may be attached to pergola 10 manually in a twist-and-lock manner without the need for other tools.

In reference to FIG. 2A, head 24 of clip 20 may have an elongated (i.e., oblong) shape having longitudinal head axis HA. A hand of a user may grab body 26 of clip 20 to align head 24 with channel 18 and also orient head 24 so that head axis HA is visually close to being parallel with channel axis CA. With clip 20 disposed in the orientation shown in FIG. 2A, clip 20 may be brought toward channel 18 and head 24 of clip 20 may be inserted into channel 18.

In reference to FIG. 2B, head 24 of clip 20 is shown to be fully inserted into channel 18 and held in place by the hand of the user. In this orientation of clip 20, head axis HA may be oriented to be substantially parallel to channel axis CA.

In reference to FIG. 2C, head 24 of clip 20 is shown to have been rotated by about 90° in the clockwise direction (see arrow CW) in order to lock clip 20 in place along channel 18. In this orientation of clip 20, head axis HA may be oriented to be substantially perpendicular to channel axis CA. With clip 20 locked in place along channel 18, clip 20 may be ready to be used for attaching one or more objects 22 to post 12 or to beam 14. Accordingly, one or more objects 22 may be engaged with body 26 of clip 20 as shown in FIG. 1.

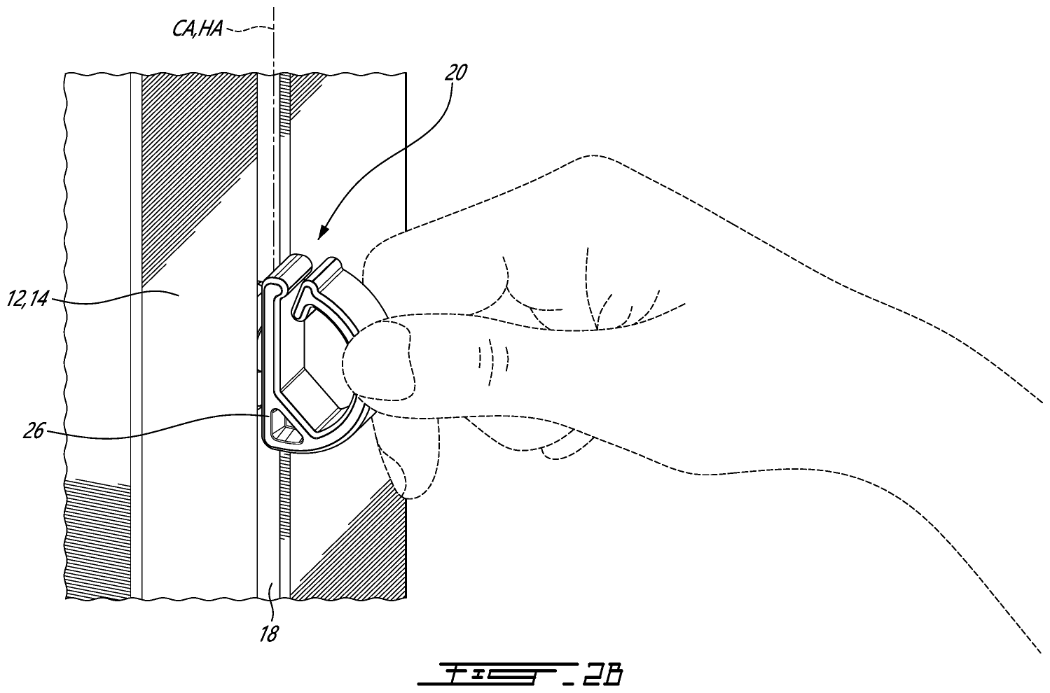

FIG. 3 is a cross-sectional profile of post 12 of pergola 10 taken along line 3-3 in FIG. 1. Post 12 may extend substantially vertically and may have one more channels 18 extending therealong. Channel(s) 18 may be suitable for engagement with one or more clips 20 or other clips. Post 12 may have a generally square or other cross-sectional shape. In some embodiments, one or more channels 18 may be disposed on one or more sides of post 12. In some embodiments, post 12 may be hollow. In some embodiments, post 12 may be a metallic or polymeric extrusion. In various embodiments, one or more channels 18 may extend along an entire length of post 12 or only partially along the length of post 12.

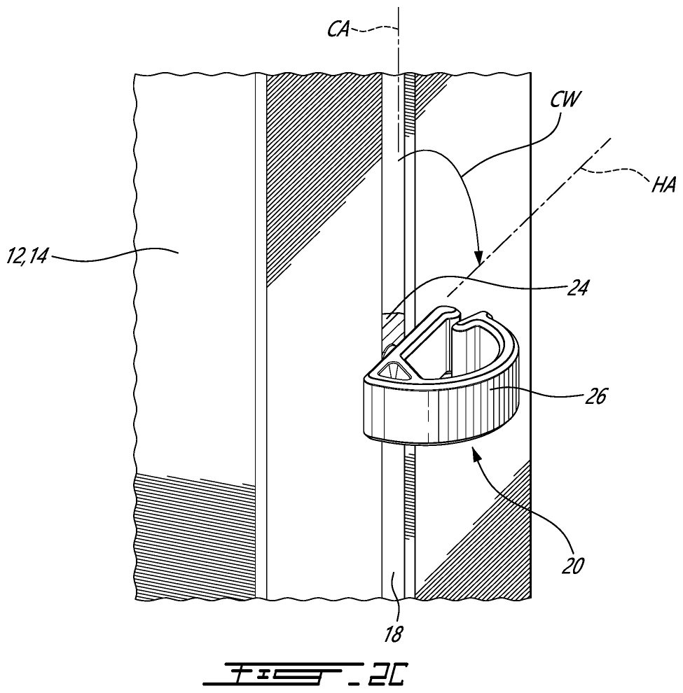

FIG. 4 is a cross-sectional profile of beam 14 of pergola 10 taken along line 4-4 in FIG. 1, together with clip 20 attached to beam 14 by way of engagement of head 24 with one of channels 18. Beam 14 may extend substantially horizontally and may have one more channels 18 extending therealong. Channel(s) 18 may be suitable for engagement with one or more clips 20 or other clips. Beam 14 may have a generally rectangular or other cross-sectional shape. In some embodiments, one or more channels 18 may be disposed on one or more sides of beam 14. In some embodiments, beam 14 may be hollow. In some embodiments, beam 14 may be a metallic or polymeric extrusion. In various embodiments, one or more channels 18 may extend along an entire length of beam 14 or only partially along the length of beam 14.

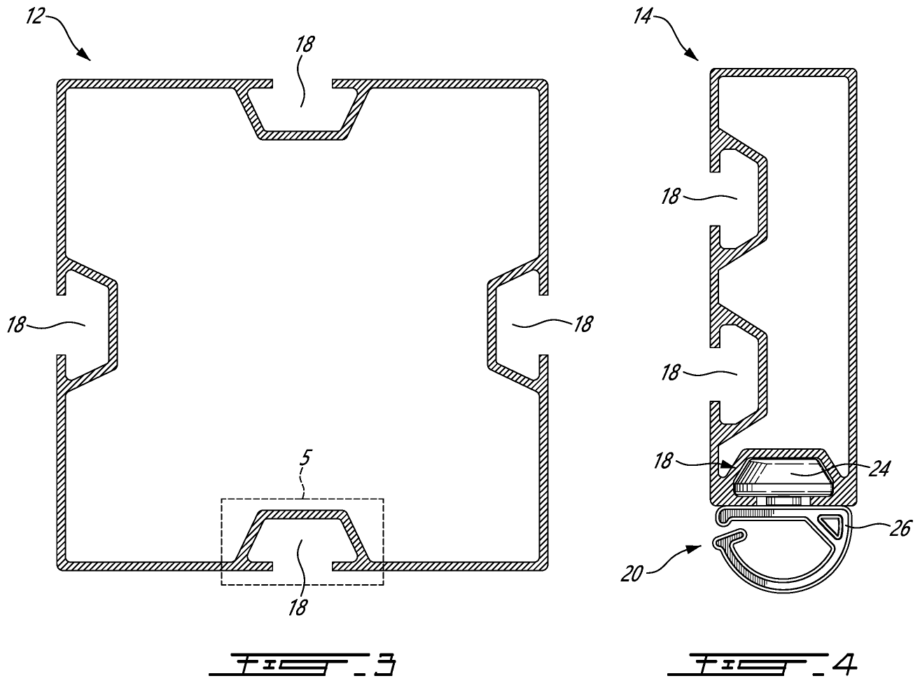

FIG. 5 shows an enlarged portion of region 5 in FIG. 4 showing one of channels 18 the cross-sectional profile of post 12 of FIG. 3 together with a front view of clip 20 suitable for attachment with post 12. In some embodiments, one or more channeled frame members (e.g., one or more beams 14 and/or one or more posts 12) may be combined with one or more clips 20 and/or other types of clips (e.g., as disclosed herein) to form kit 28. In some embodiments, such kit 28 may include other components (e.g., frame member(s), roof surface(s), fastener(s), bracket(s)) suitable for assembling pergola 10 or other outdoor structure(s).

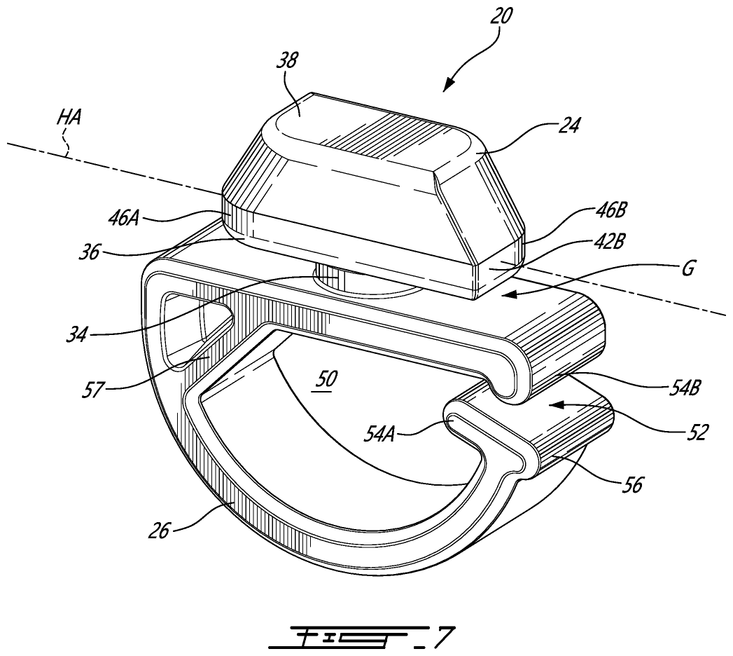

Post 12 may include one or more flanges 30 at least partially defining opening 32 of channel 18. In some embodiments, opening 32 of channel 18 may be defined between to opposing flanges 30. For example, flanges 30 may be spaced apart by distance W corresponding to width W of opening 32. Width W of opening 32 may be greater than width w (shown in FIG. 8) of head 24 of clip 20 so that W>w to permit the insertion of head 24 into channel 18 when channel 18 and clip 20 are oriented as shown in FIG. 2A. In some embodiments, flanges 30 may have substantially the same thickness T. In some embodiments, channel 18 may have a substantially uniform cross-sectional profile along channel axis CA so that clip 20 may be installed at various locations along channel axis CA.

Head 24 of clip 20 may be attached to body 26 via neck 34. In some embodiments, head 24 may be rigidly attached to body 26 so that head 24 may not be rotatable or movable relative to body 26. However, in other clip embodiments disclosed herein, head 24 may be rotatable relative to body 26 via a pivot connection. When clip 20 is installed on post 12, neck 34 may extend between flanges 30 and be spaced apart from one or both flanges 30 as shown in FIG. 4. For example, diameter d (shown in FIG. 8) of neck 34 may be smaller than width W of opening 32. In some embodiments, neck 34 may be substantially centrally located between flanges 30 when clip 20 is installed on post 12.

Head 24 and body 26 may be positioned relative to each other to define gap G therebetween. In some embodiments, gap G may extend completely around neck 34 when neck 34 is disposed substantially centrally of head 24 for example. Gap G may have thickness t, which may be smaller than thickness T of flanges 30 so that T>t.

Upon rotation of head 24, when head 24 is inserted into channel 18, flanges 30 may be received inside gap G on both sides of neck 34. The smaller thickness t of gap G relative to thickness T of flanges 30 may result in an interference fit (i.e., press fit or friction fit) between flanges 30 and clip 20. For example, flanges 30 may be press-fitted between head 24 and body 26 to produce a joint between post 12 and clip 20 held together by friction when clip 20 is locked in place. In other words, the interference fit may cause some elastic extension of neck 34 to cause flanges 30 to be clamped between head 24 and body 26.

The difference between thickness T and thickness t (i.e., amount of interference) may be selected based on the mechanical properties of the materials of clip 20 and of post 12, the size of the area of contact, and the tightness of the fit required to produce the desired retaining friction force between clip 20 and post 12. In some embodiments, thickness T of flanges 30 may be greater than thickness t of gap G by an amount between 0.1 mm and 0.5 mm for example. Rounded edge 36 on the lower part of head 24 may facilitate the insertion flanges 30 into gap G by providing a gradual tensile loading of neck 34 as flanges 30 are progressively inserted in gap G when head 24 is rotated. In other words, rounded edge 36 may provide a camming surface for engagement. The frictional engagement of clip 20 with post 12 may permit clip 20 to be installed in non-horizontal (e.g., oblique and vertical) channels 18 and carry some payload without sliding down channel 18.

Head 24 and the cross-sectional profile of channel 18 may have cooperating shapes so as to provide a relatively secure mating engagement between clip 20 and post 12. For example, head 24 and channel 18 may be shaped to provide some positional interlocking in one or more degrees of freedom. In some embodiments, head 24 may be tapered in a direction away from body 26. In some embodiments, the cross-sectional profile of channel 18 may taper in a direction away from opening 32 of channel 18.

In some embodiments, one or more other surfaces of head 24 may become engaged with one or more inner surfaces of post 12 defining channel 18. For example, head 24 of clip 20 may have top surface 38 at a distal extremity of head 24 opposite body 26, and channel 18 may have back surface 40 opposite opening 32 of channel 18. When clip 20 is installed on post 12, top surface 38 of head 24 may be in contact with back surface 40 of channel 18. In some embodiments, top surface 38 of head 24 may be pressed against back surface 40 of channel 18 to provide further frictional engagement between clip 20 and post 12.

Clip 20 may be made from a metallic or polymeric material. In some embodiments, clip 20 may be made by injection molding from a thermoplastic material such as polyphenylene ether (PPE) for example.

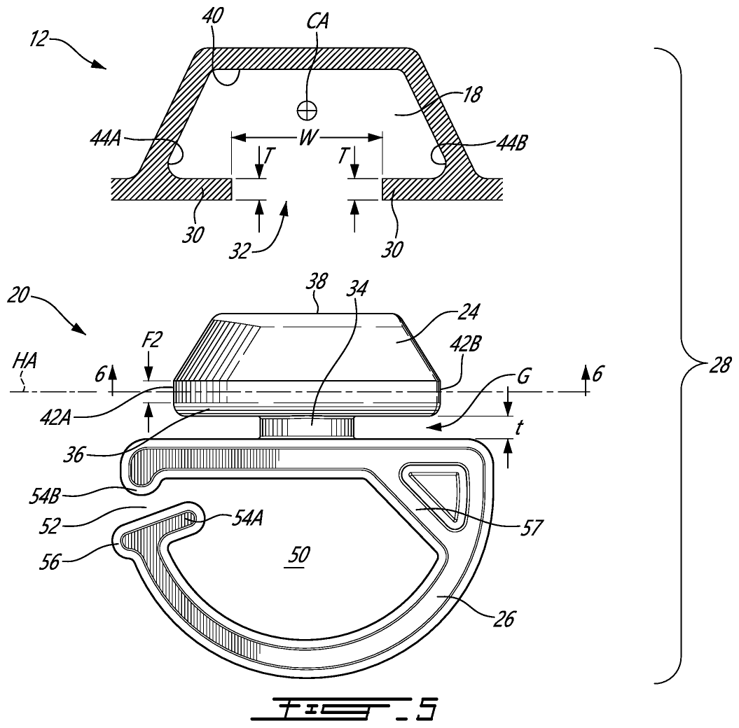

FIG. 6 is a schematic view of cross-sectional profiles 24-1 and 24-2 of head 24 of clip 20 taken along line 6-6 in FIG. 5 and shown relative to channel 18. Profile 24-1 represents the situation illustrated in FIG. 2B where head 24 is oriented so that head axis HA is substantially parallel to channel axis CA and head 24 has been inserted into channel 18 but not yet rotated to cause locking. Accordingly, profile 24-1 may represent an unlocked position of clip 20. Profile 24-2 represents the situation illustrated in FIG. 2C where head 24 has been rotated clockwise by about 90 degrees so that head axis HA is substantially perpendicular to channel axis CA to cause locking of clip 20 with post 12 or beam 14. Accordingly, profile 24-2 may represent a locked position of clip 20.

Head 24 may have opposite axial ends 42A, 42B (e.g., flat surfaces) that may become in contact with opposite side surfaces 44 of channel 18 when clip 20 is installed on post 12. In some embodiments, opposite axial ends 42A, 42B of head 24 may be pressed against respective opposite side surfaces 44A, 44B of channel 18 to provide further frictional engagement between clip 20 and post 12. The size and area of axial ends 42A, 42B may be selected to provide the desired frictional engagement with channel 18. In some embodiments, width F1 (shown in FIG. 6) of the flat surfaces of axial ends 42A, 42B may be about 4 mm or greater for example. In some embodiments, height F2 (shown in FIG. 5) of the flat surfaces of axial ends 42A, 42B may be less than the width F1. In some embodiments, a height F2 may be between 1 mm and 3 mm for example. In some embodiments, the flat surfaces of axial ends 42A, 42B may be in a non-tapered portion of head 24 and the tapered portion of head 24 may be disposed above the flat surfaces of axial ends 42A, 42B in reference to FIG. 5.

In reference to FIG. 6 again, rounded camming surfaces 46A, 46B disposed on diagonally opposite corners of head 24 may facilitate the rotation of head 24 when inside channel 18 by providing a gradual engagement and pressing of camming surfaces 46A, 46B and axial ends 42A, 42B of head 24 against respective side surfaces 44A, 44B of channel 18 as head 24 is rotated to the locked position. In other words, rounded camming surfaces 46A, 46B may provide a camming engagement of axial ends 42A, 42B with respective side surfaces 44A, 44B.

Head 24 may also be shaped to provide tactile feedback indicating to the user that head 24 has reached the locked position. For example, substantially flat axial ends 42A, 42B being engaged with respective side surfaces 44A, 44B and the presence of sharp edges 48A, 48B disposed on diagonally opposite corners of head 24 may prevent rotation of head 24 past the locked position. When head 24 reaches the locked position, the resistance to further rotation of head 24 may increase significantly thereby indicating to the user that the locked position has been reached. The shape of head 24 may also prevent head 24 from being rotated beyond a limit of less than 90° in the opposite counter clockwise direction from the unlocked position to indicate to the user that locking of head 24 may be achieved by rotation in the clockwise direction only. One or more objects 22 may be engaged with body 26 of clip 20 so that such object(s) 22 may be attached to post 12 via clip 20.

Removal/disengagement of head 24 from channel 18 may be achieved by rotation of head 24 in the opposite (e.g. counter clockwise) direction from the locked position of profile 24-2 back to the unlocked position of profile 24-1, and subsequent withdrawal of head 24 from channel 18. It is understood that the shape of head 24 could alternatively be configured to cause locking by counter clockwise rotation and cause unlocking by clockwise rotation by switching the locations of camming surface 46A, 46B and sharp edges 48A, 48B. Even though the above description of the installation (and withdrawal) of clip 20 is made in reference to post 12, the same description also applies to the installation (and withdrawal) of clip 20 on beam 14.

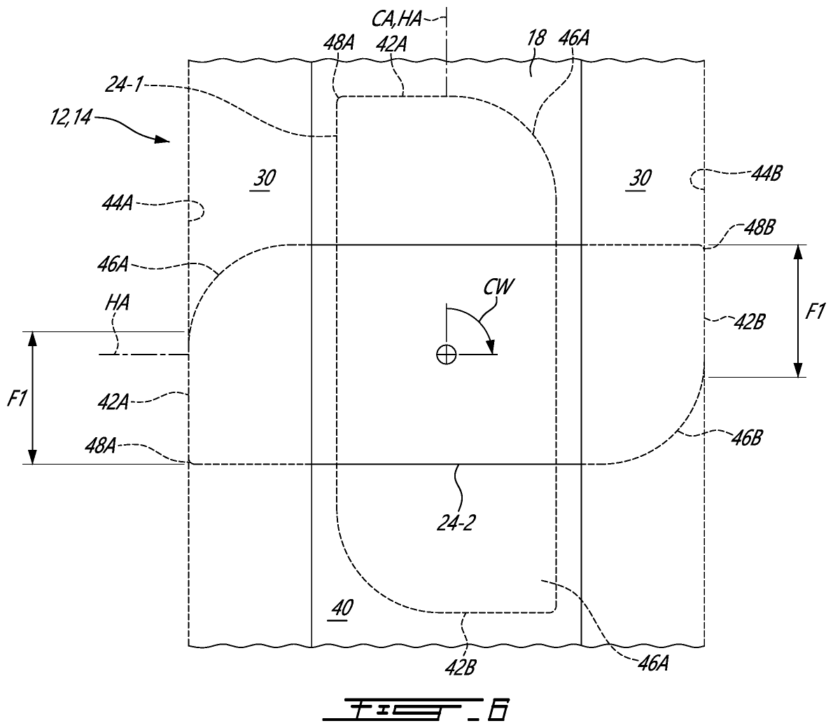

FIG. 7 is a perspective view of clip 20. Body 26 of clip 20 may include a hook for engagement with one or more objects 22. The hook may define throat 50 in which object(s) 22 may be disposed when supported by clip 20, and mouth 52 via which object(s) 22 may be inserted into throat 50 or removed from throat 50. In some embodiments, body 26 may include one or more ledges 54A, 54B to hinder object(s) 22 from inadvertently becoming disengaged from the hook defined by body 26. Ledges 54A, 54B may be disposed at or near mouth 52. Ledge 54A may include a protrusion extending into throat 50. Ledge 54A may include a protrusion extending into mouth 52. In some embodiments, body 26 may include one or more tabs 56 to facilitate the manipulation of clip 20 and/or to facilitate the opening or closing of the hook when engaging or disengaging object(s) 22 with/from clip 20 by manually bending the structure of body 26 to adjust the size of mouth 52.

In some embodiments, body 26 may include brace 57 in a corner region of throat 50 defined by the hook configuration of body 26. Brace 57 may impart rigidity and/or strengthening of the hook structure of body 26. For example, brace 57 may reinforce an internal corner region of the hook structure. In various embodiments, brace 57 may include a region of increased thickness, a chamfer between adjacent faces, and/or a reinforcing rib (e.g., integrally) formed in body 26.

FIG. 8 is a left side view of clip 20.

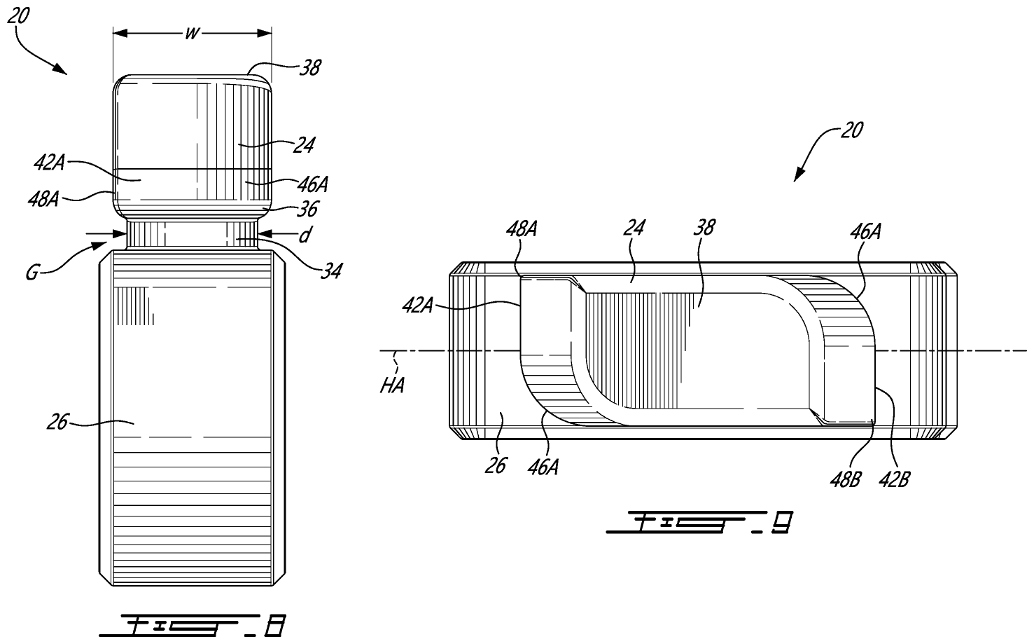

FIG. 9 is a top view of clip 20.

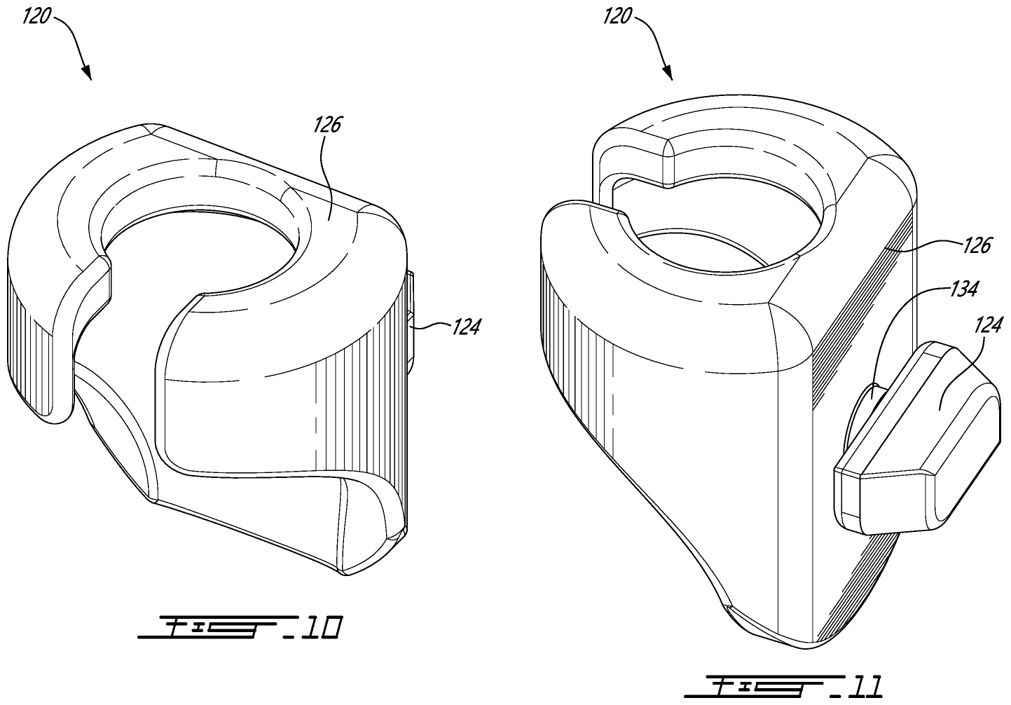

FIGS. 10 and 11 are perspective views of another exemplary clip 120. Clip 120 may include elements of clip 20 described above and like elements are identified using reference numerals that have been incremented by 100. Clip 120 may include head 124, which may be used to attach clip 120 to a frame member using channel 18 as described above in relation to clip 20. Head 124 may be fixedly attached to body 126 via head 134. Body 126 may define a toggle ball holder which may be adapted to receive a toggle ball associated with an adjustable (e.g., roller) blind for example.

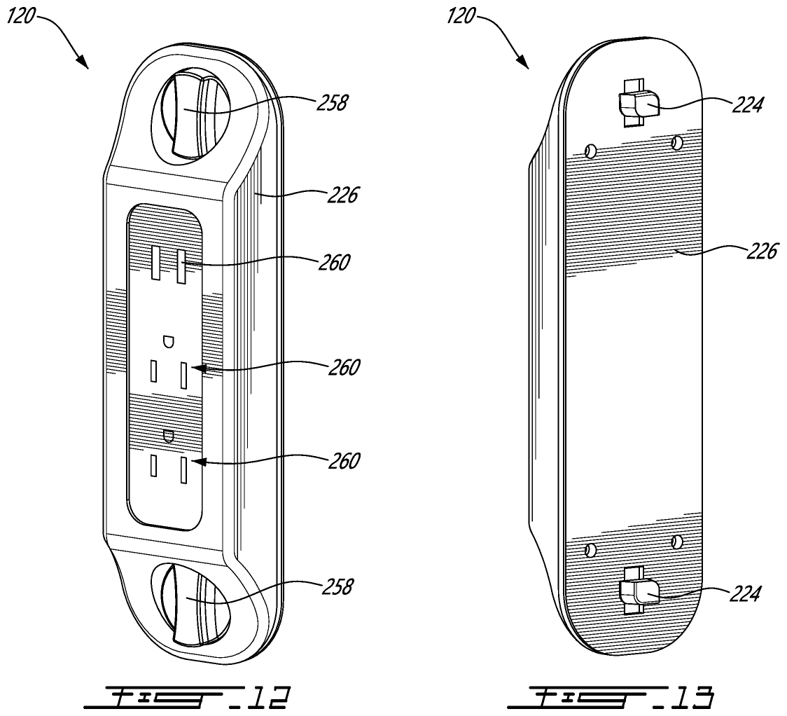

FIGS. 12 and 13 are perspective views of another exemplary clip 220. Clip 220 may include elements of clip 20 described above and like elements are identified using reference numerals that have been incremented by 200. Clip 220 may include two heads 224, which may be used to attach clip 220 to a frame member using channel 18 as described above in relation to clip 20. Heads 224 may be rotatably attached to body 226 via respective pivot connections. Heads 224 may be independently rotatable and attachable to a same channel 18 of a frame member to frictionally engage with surface(s) defining channel 18. Each head 224 may be attached to its own knob 258 accessible from a front side of clip 220 to facilitate manual rotation of each head 224 separately when locking heads 224 with channel 18. Body 226 may include an electric receptacle holder. For example, body 226 may hold an electric power hub including one or more receptacles 260 such as universal serial bus (USB) charging port(s) and/or single phase (e.g., 110 volts) power outlet(s) electrically connected to a power source (not shown).

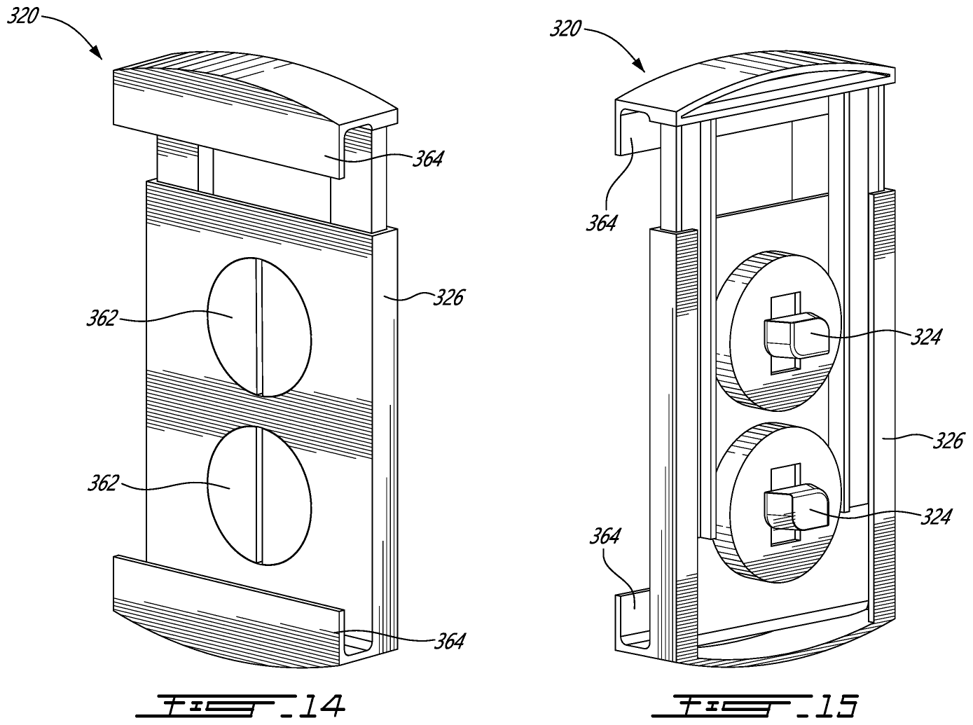

FIGS. 14 and 15 are perspective views of another exemplary clip 320. Clip 320 may include elements of clip 20 described above and like elements are identified using reference numerals that have been incremented by 300. Clip 320 may include two heads 224, which may be used to attach clip 320 to a frame member using channel 18 as described above in relation to clip 20. Heads 324 may be rotatably attached to body 326 via respective pivot connections. Heads 324 may be independently rotatable and attachable to a same channel 18 of a frame member to frictionally engage with surface(s) defining channel 18. Each head 324 may be attached to its own driver 362 accessible from a front side of clip 320 to facilitate rotation of each head 324 separately when locking heads 324 with channel 18. In some embodiments, drivers 362 may each include features (e.g., recesses, protrusions) that permit rotation of drivers 362 manually (e.g., as a knob) by a user without the use of tools. In some embodiments, drivers 362 may each include a slot that permits rotation of drivers 362 using a coin or a flat head screw driver for example.

Body 326 may include an electronic display device holder. For example, body 326 may include grippers 364 than may be configured to engage with a top side and a bottom side of an electronic display device such as a smartphone, tablet computer, and/or a laptop computer for example. In some embodiments, one or more of grippers 364 may adjustable/movable relative to each other to accommodate different sizes of electronic display devices.

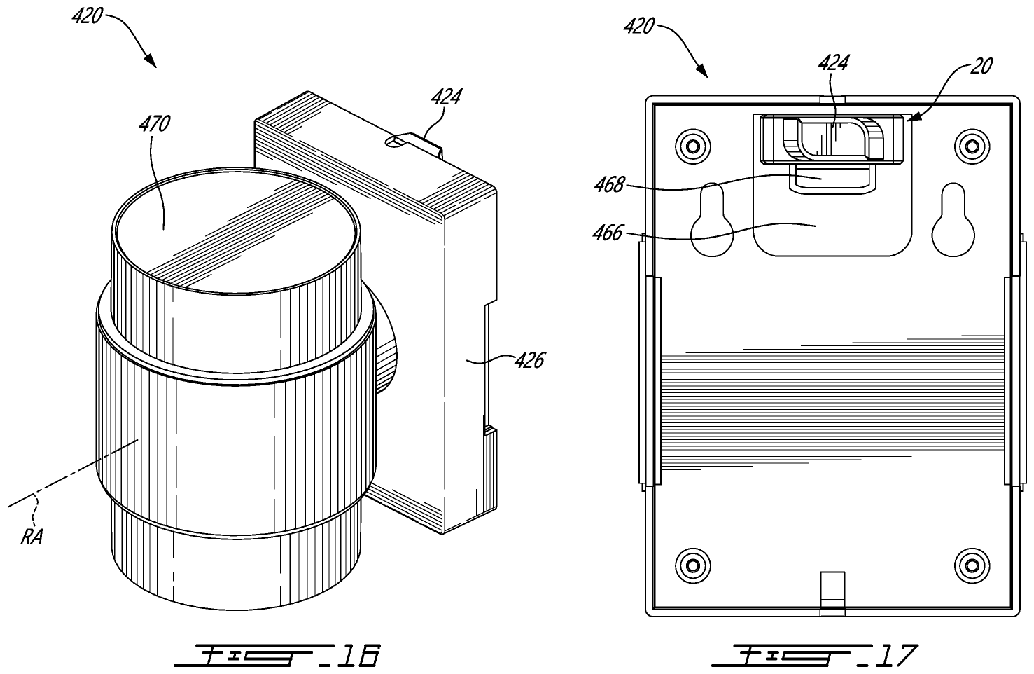

FIGS. 16 and 17 are perspective and rear views respectively of another exemplary clip 420. Clip 420 may include elements of clip 20 described above and like elements are identified using reference numerals that have been incremented by 400. Clip 420 may include head 424, which may be used to attach clip 420 to a frame member using channel 18 as described above in relation to clip 20. In some embodiments, head 424 may be integrally formed (i.e., have a unitary construction) with body 426 or otherwise be rigidly and permanently attached to body 426. Alternatively, head 424 may be provided via clip 20, which may then be engaged with body 426. For example, body 426 may include receptacle 466 defined on a back side thereof for receiving body 26 of clip 20. Body 426 may also include anchor 468 (e.g., downwardly extending peg) which may be received in throat 50 of clip 20 for engaging body 426 with clip 20. During installation, clip 20 may first be installed on the frame member and then body 426 may be engaged with (e.g., hung on) clip 20 using anchor 468.

Clip 420 may include a lamp holder for holding lamp 470 such as a spot light for example. In some embodiments, lamp 470 may be rotatable about rotation axis RA relative to the remainder of body 426 via a pivot connection.

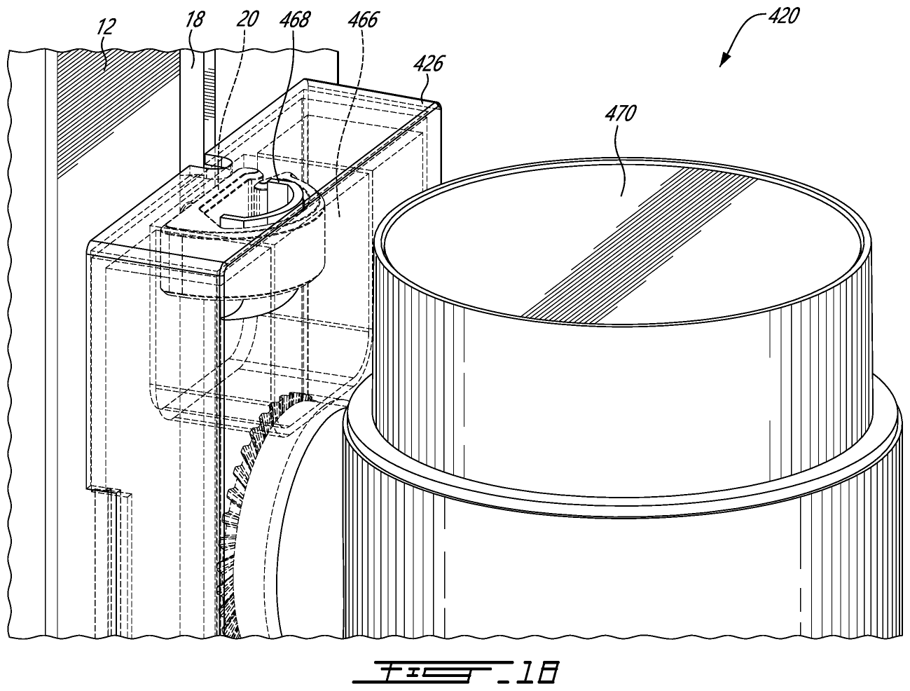

FIG. 18 is a perspective partially transparent view of part of clip 420 attached to post 12 via channel 18. Part of body 426 is shown as being partially transparent to illustrate the engagement of body 426 with clip 20 via anchor 468. Elements inside of body 426 are shown in broken lines except for anchor 468 being shown in solid lines for clarity. Anchor 468 may be attached to (e.g., integrally formed with) a top wall of body 426.

The embodiments described in this document provide non-limiting examples of possible implementations of the present technology. Upon review of the present disclosure, a person of ordinary skill in the art will recognize that changes may be made to the embodiments described herein without departing from the scope of the present technology.

1. An outdoor structure for an outdoor living space, the outdoor structure comprising:
a post extending substantially vertically and having a channel extending along the post;
a beam supported by the post and extending transversally to the post; and
a clip for attaching an object to the post, the clip including:
a head received in the channel of the post and frictionally engaged with one or more surfaces defining the channel; and
a body attached to the head and configured to engage with the object.

2. The outdoor structure as defined in claim 1, wherein:
the post includes a flange partially defining an opening of the channel;
the head and the body of the clip define a gap therebetween; and
the flange is received in the gap and press-fitted between the head and the body.

3. The outdoor structure as defined in claim 2, wherein:
the flange is a first flange;
the post includes a second flange, the opening of the channel being defined between the first flange and the second flange; and
the second flange is received in the gap and press-fitted between the head and the body.

4. The outdoor structure as defined in claim 3, wherein:
the head is attached to the body via a neck extending between the first flange and the second flange; and
the neck is spaced apart from both the first flange and the second flange.

5. The outdoor structure as defined in claim 2, wherein:
the head of the clip is tapered away from the body;
the channel has a longitudinal channel axis and a cross-sectional profile in a plane normal to the longitudinal channel axis; and
the cross-sectional profile of the channel tapers away from the opening of the channel.

6. The outdoor structure as defined in claim 2, wherein:
the head of the clip has a top surface at a distal extremity of the head opposite the body;
the channel has a back surface opposite the opening of the channel; and
the top surface of the head of the clip is in contact with the back surface of the channel.

7. The outdoor structure as defined in claim 1, wherein:
the head has an elongated shape having a longitudinal head axis; and
opposite axial ends of the head along the longitudinal head axis are in contact with opposite side surfaces of the channel.

8. The outdoor structure as defined in claim 1, wherein the head is rotatably attached to the body.

9. The outdoor structure as defined in claim 1, wherein the clip includes two independently rotatable heads frictionally engaged with the one or more surfaces defining the channel.

10. The outdoor structure as defined in claim 1, wherein the body includes a hook.

11. The outdoor structure as defined in claim 10, wherein the hook includes a ledge to hinder the object from becoming disengaged from the hook.

12. The outdoor structure as defined in claim 10, wherein the hook includes a tab to facilitate opening or closing of the hook.

13. The outdoor structure as defined in claim 10, wherein the hook includes a brace in a corner region of a throat of the hook to reinforce the hook.

14. The outdoor structure as defined in claim 1, wherein the body includes a toggle ball holder.

15. The outdoor structure as defined in claim 1, wherein the body includes an electric receptacle holder.

16. The outdoor structure as defined in claim 1, wherein the body includes an electronic display device holder.

17. The outdoor structure as defined in claim 1, wherein the body includes a lamp holder.

18. The outdoor structure as defined in claim 1, wherein the outdoor structure is a pergola.

19. A kit comprising:
a frame member defining a channel, the frame member including a flange at least partially defining an opening of the channel, the flange having a flange thickness; and
a clip for attaching an object to the frame member, the clip including:
a head sized to be received in the channel via the opening and frictionally engaged with the channel upon rotation of the head when the head is received in the channel; and
a body attached to the head and configured to engage with the object, the head and the body defining a gap therebetween for receiving the flange when the head is frictionally engaged with the channel, the gap having a gap thickness that is smaller than the flange thickness to define an interference fit between the flange and the clip.

20. (canceled)

21. The kit as defined in claim 19, wherein:
the flange is a first flange;
the frame member includes a second flange, the opening of the channel being defined between the first flange and the second flange; and
the gap is configured to:
receive the second flange therein when the head is frictionally engaged with the channel; and
define an interference fit between the second flange and the clip.

22.-27. (canceled)

28. A clip for attaching an object to a channeled frame member in a tool-less manner, the channeled frame member including flanges defining an opening of a channel therebetween, the flanges having a flange thickness, the clip comprising:
a head sized to be received in the channel via the opening and frictionally engaged with the channel upon rotation of the head when the head is received in the channel; and
a body attached to the head and configured to engage with the object, the head and the body defining a gap therebetween for receiving the flanges when the head is engaged with the channel, the gap having a gap thickness that is smaller than the flange thickness to define an interference fit between the flanges and the clip.

29. (canceled)

30. The clip as defined in claim 28, wherein the head is rotatable relative to the body.

31. The clip as defined in claim 28, wherein the clip includes two independently rotatable heads to be received in the channel via the opening and frictionally engaged with the channel upon rotation of the heads when the heads are received in the channel.

32.-36. (canceled)

37. A method of attaching an object to a frame member in a tool-less manner, the frame member including two flanges defining therebetween an opening of a channel extending along the frame member, the method comprising:
when a head of a clip is inserted into the channel of the frame member and the head of the clip is rotated relative to the channel:
causing frictional engagement between the head and one or more surfaces defining the channel;
receiving the two flanges into a gap defined between the head and a body of the clip; and
press-fitting the two flanges between the head and the body of the clip to define an interference fit between the clip and the two flanges; and
attaching the object to the clip.

38. The method as defined in claim 37, wherein the frame member is oriented substantially vertically.

39. The method as defined in claim 37, wherein the frame member is oriented substantially horizontally.

40. The method as defined in claim 37, comprising cammingly engaging the head with the one or more surfaces defining the channel.
